(19) United States
(12) Patent Application Publication
(10) Pub. No.: US 2016/0063985 A1
(43) Pub. Date: Mar. 3, 2016

(54) SOUND ABSORBERS

(71) Applicant: ISOLITE GmbH, Ludwigshafen (DE)

(72) Inventors: Michael KNOLL, Birkenau (DE); Matthias KROLL, Dackenheim (DE); Karl Christian REGENT, Wolfenbuttel (DE); Bernd HENRICH, Mannheim (DE)

(21) Appl. No.: 14/840,111

(22) Filed: Aug. 31, 2015

(30) Foreign Application Priority Data
Sep. 1, 2014 (EP) 14183067.9

(51) Int. Cl. G10K 11/162; B29C 44/34

(52) U.S. Cl. CPC G10K 11/162; B29C 44/3415

(57) ABSTRACT

Balls changing volume when activated efficiently filing a gap providing acoustic and thermal insulation. A method of manufacturing of means for acoustic and thermal insulation, particularly at high temperatures, comprising providing an insulating and damping material; shaping of the insulating and damping material having geometric shapes, such as spherical or elliptical shapes, by a shaping processes, such as forming into a ball and/or foaming up.

### FIELD OF THE INVENTION

The invention relates to a method of manufacturing means for acoustic and thermal insulation, particularly in the high temperature range, and means which are produced according to this method. Further, the invention corresponds to a method for the production of high-temperature sound absorbers using the means as well as high-temperature sound absorber produced by this method.

### BACKGROUND OF THE INVENTION

It is known that sound absorbers can have sound absorbing and insulating materials. The sound absorbers on the one hand may be assembled in layers. However, a layered structure, for example the insertion of mats is not always possible and, moreover, has problems to fill in complex geometric structures. Further problems may also result when welding shell sound absorbers from fiber filaments sticking out. Another possibility is that the sound-absorbing material is introduced prior to closing of the sound absorber. However, it is a problem that voids, gaps or similar portions of the sound absorber can be difficult to reach. If the material is introduced into bags, such as plastic bags, it may be very difficult to have an application-specific shaping of the material with respect to corners, angles or undercuts is very difficult. Moreover, residues or emissions of bags, such as plastic bags, that are used can be problematic.

Another possibility is described in EP 1 861 592, wherein an optical fiber is wound on a tube or roll winder, which is then removed so that finally a flattened tubular mass is obtained, which is used to produce a prefabricated mattress. But a problem here is that this process can be complicated and the obtained mattresses for some application-specific shaping are not sufficiently well suited.

### SUMMARY OF THE INVENTION

In view of the problems in the prior art, the object of the present invention is to provide an easier possibility for an insulating and damping material, for the production of this insulation and damping material and a sound absorber using this insulating and damping material, and a process for its manufacturing.

This object is achieved by a method of manufacturing of means for acoustic and thermal insulation, particularly at high temperatures according to an embodiment of the invention, and means which are produced according to the method; achieved according to embodiments of the invention, as well as according to a method for the production of high-temperature sound absorbers according to an embodiment of the invention, using the means and with this method, high-temperature sound absorber produced according to another embodiment.

The invention provides a method of manufacturing of means for acoustic and thermal insulation, particularly in the high temperature range, the method comprising: providing an insulating and damping material; shaping or molding the insulating and damping material having geometric shapes, such as spherical or elliptical shapes, by shaping processes, such as forming into a ball and/or foaming up.

The manufacturing means, especially substantially spherical or elliptical balls of insulating and damping material for acoustic and thermal insulation has the advantage of making available units which are small and controllable in diameter as molding material, which may be introduced in a simple manner into settings of most diverse forms. Here, the density and the diameter of the means can be variably selected. These means can be produced in a simple manner and in large numbers. In principle they may also be used for pre-existing cavities. It is understood that a shape of the insulating and damping material having geometric shapes, such as spherical or elliptical shapes, by shaping processes, for example forming into a ball and/or foaming up can be done without using a bobbin or tubular body.

Due to the configuration of the insulation and damping body with respect to density and design both a maximum space filling and thus a permanent insulating effect, as well as an optimal acoustic design, in particular reduction of acoustic peaks is given. In order to obtain maximum space filling, the variable shaped bodies can be matched.

In the method, a binder may be added as an additive prior to or during or after shaping. The addition of a binder is optional. Through a binder, a firmer shape may be achieved.

In the method, the insulating and damping material may comprise a textile fiber, a silicate glass fiber, a ceramic fiber; or may comprise a mixture of several of these fibers.

For the means, common insulating and dampening may be used. For the fiber the use of fiber glass-made mineral fibers, carbon fibers, silicate glass fibers, aramid, natural fibers, cotton, steel fibers, plastic fibers is possible. In particular textile glass fibers or silicate glass fibers are less expensive to produce than ceramic fibers. Also, the environmental compatibility of silicate glass fibers is better than that of other fibers.

In the method the insulating and damping material may be at least partially formed from continuous fiber.

A filament with virtually no limited length is called a continuous fiber. This may include a bundle (multifilament or multifil) comprising several individual filaments.

In the method, the continuous fiber may be fibers sold under the trademarks POWERTEX®, or ADVANTEX®, a commercially available ECR fiber or a standard E-glass fiber.

The corresponding continuous fiber may provide excellent properties in the area of acoustic and thermal insulation.

In the method, the insulating and damping material may include foams, in particular solid foams. The foams may include, for example, one or more types of foam selected from foamed material, pumice, assembly foams, foam glass, aerogels. It is understood that other types of foam may be possible.

The method as described above may further comprise the step of setting a temperature above which the insulating and damping material changes its volume only at a first heating thereby activating the material, and in particular increases its volume. In particular, additives to be added allow for expansion during the first heating and thus a change in volume of the insulating body.

The insulating and damping material may change its properties once above a threshold temperature or activation temperature. By applying the material with this activation temperature over a given period the material may change, for example, its volume, and in particular it may increase its volume. A typical activation temperature is in the range between 400° and 500° C., typically 450° C. However, other temperatures are possible.

In the method, the diameter of the ball type means shaped in geometrical forms, in particular spherical or elliptical, may vary starting from 3 mm. It is understood that this is the diameter before activating or heating.

The variation in diameter which is just of importance before the expansion activation in order to allow a uniform and possibly complete filling of the space to be insulated. Following initial exposure to the activation temperature on the one hand the fibers may expand and on the other hand an optionally added binder may evaporate, whereby a substantially homogeneous insulating structure is produced. In view of elliptical or ellipsoidal shapes, especially spheroids, the diameter starting from 3 mm refers to the smaller or smallest diameter describing these shapes.

The diameter of the means for acoustic and thermal insulation can be customized to different applications by any shaping method such as forming into a ball and/or foaming up. It is understood that means having different diameters may be provided for different applications.

In the method the ball shaped means may be spherical, and may include two types of ball shaped means having two different radii, respectively, wherein the ratio of the two radii is constant and in particular the ratio of the radii may be about 2.415.

The radii R and r relate to two mutually designed spherical diameter of the insulating and damping material prior to expansion. To obtain a maximum, optimum space filling, the variable shaped bodies may be matched. In particular, this is possible for two types of molded bodies, the material of which may be the same, but whose spherical diameter or radii each are different. The aim here is to increase the space-filling prior to expansion and thus to achieve a homogeneous distribution of insulation and dampening material after expansion. This can have a positive effect on the thermal issues and acoustics, since possible hotspots and cavities may be avoided. An example of a maximum space filling may be given for the matching of sphere diameters for two different radii R and r, where a particularly good space filling can be achieved for a ratio of R/r=2.415. The various radii may be achieved for example by compression of the material.

The invention further provides means for acoustic and thermal insulation, wherein the means are prepared according to the method described above.

The invention further provides means for acoustic and thermal insulation comprising a fibrous insulation and damping material, and in particular a binder, said fibrous insulating and damping material being formed into geometric shapes, such as spherical or elliptical shapes.

The means for acoustic and thermal insulation can be used in many ways in the sound absorption range.

The invention also provides a method for manufacturing high-temperature available sound absorbers, the method comprising: providing a first casing shell; providing a second casing shell or a direct hot gas-carrying member; providing means for acoustic and thermal insulation as described above; connecting the first casing shell with the second casing shell or the direct hot gas carrying component such that a gap is created between them, which is at least partially enclosed by the casing shells; introducing the means into the gap between the first and second casing shell or the direct hot gas-carrying member; activating the means in the gap.

The means described above can be used in particular in a method for the production of high-temperature sound absorbers. A gap is to be understood as a clearance space between the casing shells in which the means can be collected. This gap may be formed pocket-like. The gap may be closed after introduction of the means. It is understood that the sound absorber also can include a plurality of spaces which are separated from each other which can be filled with means for acoustic and thermal insulation, in particular geometric shapes, such as spherical shapes or elliptical shapes. It is also understood that in one or more of the gaps means having different diameters may be used. The amount of means, their size or their diameter and therefore the resulting density of insulating and damping material in the gap thus allow for a variable adjustment of the acoustic performance and eventually an improvement of the performance of the sound absorber produced by the method, in that the surface temperature of the absorbing part of the vehicle can be reduced. Activation, also called expansion activation, typically can be performed by heating. The step of expansion activation makes it possible to provide the insulating and damping material in the right place in its final form and its final volume for future use.

In the method introducing the means may comprise a step of pouring into the gap and/or a blowing into the gap.

The means of insulating and damping material can be introduced into the one or the many gaps by pouring the means, where appropriate, using the effect of gravity, or by blowing the means into the gaps. Thus, the insulating and damping material can be introduced in a particularly simple manner into the sound absorber. In particular, no wrapping of elements is necessary.

In the method, the activation of the expansion of the means, before or after installation of the high-temperature sound absorber can take place in a vehicle.

In the method, the activation of the expansion means of the high temperature after incorporation of the sound absorber can be done in a vehicle during a first test drive, or during a first test run of an engine in the vehicle.

The expansion allows the introduction of the insulating and damping material in place in its final form for future use, and having the final volume. Here, this step may take place before or after installation in a vehicle or a machine. If the step takes place prior to installation, the finished sound absorber can be provided. If the step takes place after installation, a particularly good adjustment to the insulating part of the vehicle may be achieved, since before activating the sound absorber it may first adapt to specific mechanical unevenness of the vehicle component to be dampened and then by activating can assume its final form in the gap of the sound absorber and may fill it as appropriate.

Furthermore, the materials used allow a significant reduction of emissions when applying the activation temperature and further when used as a sound absorber.

In the method, the first and/or second casing shell can have a perforation.

An at least partial perforation of the sound absorber may in particular conduct acoustic energy into the interior of the sound absorber. There it can be absorbed. Thus the acoustic and thermal insulation of the sound absorber can be influenced by the properties of the insulating and damping material.

The invention further comprises a high-temperature sound absorber, produced by the method as described above.

The advantages of the high-temperature sound absorber correspond to those which have already been described above in connection with the method for its manufacturing.

The invention further provides means for acoustic and thermal insulation, especially at high temperatures comprising an insulating and damping material, said insulating and damping material is manufactured ball like in geometric shapes, such as spherical or elliptical shapes, by shaping processes, for example forming into a ball and/or foaming up.

In the means, the insulating and damping material may be fibrously formed and may be at least partially formed of continuous fiber; wherein the continuous fiber is fiber sold under the trademarks POWERTEX® or ADVANTEX®, a commercially available ECR fiber or a standard E-glass fiber; or wherein the insulating and damping material may comprise foams, in particular solid foams. The foams may include, for example, one or more types of foam from foamed materials, pumice, assembly foams, foam glass, aerogels. It is understood that other types of foam may be possible.

In the following, embodiments of the invention are described with reference to the drawings. The described embodiments are to be considered in all respects only as illustrative and not restrictive, and various combinations of the listed features are included in the invention.

### BRIEF DESCRIPTION OF THE DRAWINGS

FIGS. 1A and 1B are sketches of means according to the present invention before and after activation.

FIGS. 2A and 2B are sketches of a vehicle or machine part with adjoining sound absorber according to the present invention before and after activation.

FIG. 3 is a sketch of an arrangement with optimum space filling of two types of spherical means of different radii.

FIG. 4 is a block diagram or flow chart of a method of producing a sound absorber according to the present invention.

### DETAILED DESCRIPTION OF THE INVENTION

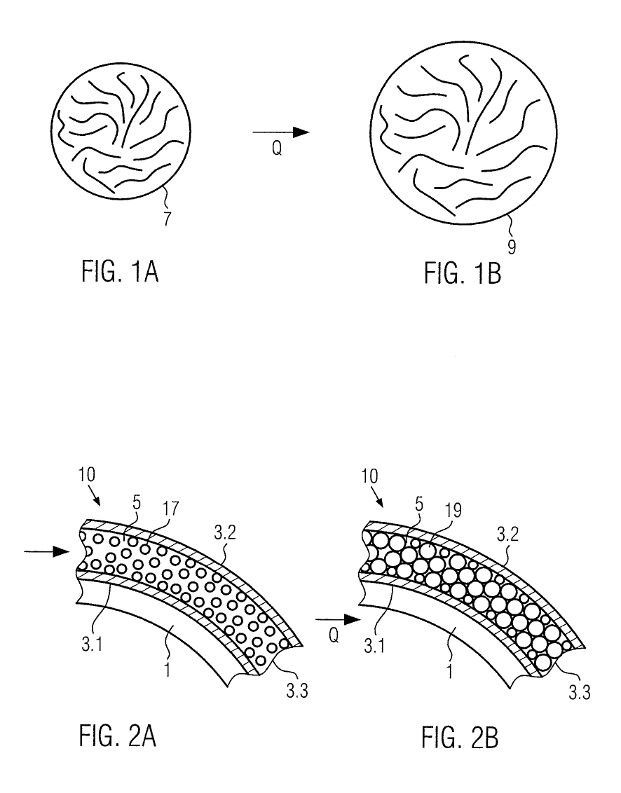

In FIG. 1A illustrates means for acoustic and thermal insulation indicated in the form of a ball 7, i.e. a substantially ball-shaped, ball like or substantially spherical body from a continuous fiber and a binder. The body can also be substantially elliptically shaped. The ball shaped means 7 can be formed by forming a ball, by winding or similar shaping method for a continuous fiber. Here no bobbin needs to be used, which would need to be pulled out from the resulting body, later. The shape indicated here shows means for acoustic and thermal insulation which can be provided with a diameter adjusted to an application. Typical diameters of the geometric means, such as spherical or elliptical, may be any starting from 3 mm, but other diameters are also possible.

In FIG. 1B illustrates that the means 7 provided for acoustic and thermal insulation, in particular ball shaped means, may change their volume and eventually their density at an activation temperature by activating or heating, i.e. by supplying heat, Q, forming means 9.

Alternatively, the means 7 can comprise insulating foams and damping material (not shown). These may be, in particular, solid foams. In this case, in particular foams may be of interest, which comprise one or more types of foam from foamed materials, pumice, assembly foams, foam glass, aerogels. It is understood that other types of foam may be possible.

FIG. 2A shows a muffler or sound absorber 10, which is fitted against a vehicle component or machine component 1 which is to be dampened. The sound absorber 10 comprises two lateral surfaces 3.1 and 3.2. In the present drawing, the two lateral surfaces are drawn apart. The element 3.3 can be an additional element and may be part of the sound absorber or it may also be formed as a portion of at least one of the two lateral surfaces 3.1 and 3.2. The two lateral surfaces 3.1 and 3.2 may be connected by means of the element 3.3 or may be even directly connected to at least one of the two sides such that a gap 5 is formed between the lateral surfaces of 3.1 and 3.2. In FIG. 2A for the sake of providing an example the gap 5 is also limited by the element 3.3. The gap 5 can be formed pocket-like, so that it may be filled with means for acoustic and thermal insulation 7, in particular ball like means having geometric shapes, such as spherical or elliptical, as shown for example in FIG. 1. The diameter of the means 7 can be suitably selected in order to fill the gap 5. It may be divided several times (not shown here). It is also possible to have multiple, separate spaces in the sound absorber, which may be filled individually.

FIG. 2A, shows a means for acoustic and thermal insulation, in particular ball shaped means having geometrical shapes, such as spherical or elliptical shapes, shown as the means 17 which can be filled into the at least one gap 5. The ball shaped means 17 having geometric shapes, such as spherical or elliptical shapes, can be the means 7 from the corresponding FIGS. 1A and 1B.

In FIG. 2B, the same elements as in the FIG. 2A are shown with the same reference numerals are used. As in FIG. 1 a heating or activating, i.e. the supply of heat, is indicated by an arrow denoted by Q. According to FIG. 1 the ball shaped means for acoustic and thermal insulation 17 of FIG. 2A change to ball shaped means for acoustic and thermal insulation 19 in FIG. 2B having a changed volume, in particular having an increased volume, and having a changed density. Here, the activation of the expansion over a predefined period of time can be carried out. Thus, as indicated in FIG. 2B, the gap between the two shell elements/settings 3.1 and 3.2 of the sound absorber 10 is particularly well filled after applying the activation temperature. A typical temperature of the expansion process is, for example in the range between 400° and 500° C., typically 450° C. This temperature T can be achieved, for example, at a first test drive of a vehicle or during a first test run of a machine. After the expansion process the volume and density of the means 19 do not change further.

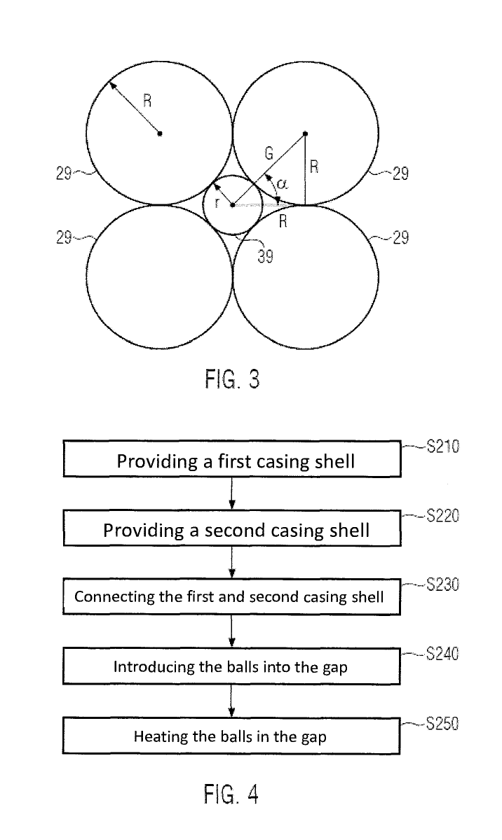

In FIG. 3, spherical means 29 and 39 are shown as insulating and damping material in a sectional view. FIG. 3 shows four approximately equal-sized spheres 29 with radius R and one smaller sphere of radius r by the numeral 39. The radii R and r refer to two mutually matched spherical diameters of the insulating and damping material to increase the space-filling before expansion/activation. The aim here is to increase the space-filling prior to expansion and thus achieve a more homogeneous distribution of the insulating and damping material after expansion. This has a positive effect on the thermal and acoustics, since any hotspots and cavities may be avoided. The respective different radii R and r of the spheres 29 and 39 can be achieved for example by compression of the material.

In FIG. 3, for example, four spheres 29 are shown, wherein the distance between adjacent spheres from center to center in each case is 2 R. FIG. 3 shows a right-angled triangle, the two sides of the length R and a hypotenuse G. The hypotenuse is at an angle α=45° to the sides of length R. The ball 39 having the radius r is in the middle of the four spheres 29 arranged so that there is a constant ratio factor K=R/r, where K is in the present example, about 2.415. This factor resulting from the geometry/goniometry for two matching ball radii R and r, is constant for every case in which the distance of the ball center points of the associated spheres amounts to 2 R. In this case, as in the illustrated, optimized arrangement of spheres of two different radii, the smaller one of the spheres may be considered as a fill-in.

FIG. 4 shows a flowchart for a method of producing a sound absorber according to the present invention.

In step S210, providing a first casing shell, element 3.1 of FIG. 2A is carried out, for the sound absorber. In step S220, providing a second casing shell, element 3.2 of FIG. 2A is carried out.

In step S230, the joining of two casing shell elements, elements 3.1 and 3.2 from FIG. 2A occurs. As discussed in FIG. 2A, the casing shells are connected such that at least one gap, element 5 is produced in FIG. 2A, between them, which can be filled with insulation and damping material in the form of balls, see also element 17 from FIG. 2A. The connection of the casing shells can take place directly or by means of another element, see item 3.3 in FIG. 2A.

In step S240, the introduction of the means 17 into the gap 5 between the casing shells 3.1 and 3.2 takes place. The amount of the means 17 as well as the diameter of the means 17 may be controlled according to a specific application.

In step S250, the activation of the expansion means for the thermal and acoustic insulation in the sound absorber is carried out. The heat required can be supplied via at least one of the two lateral surfaces, for example, during a test drive.

A mounting of the sound absorber into a vehicle or a machine may take place between the steps S230 and S240 or the steps S240 and S250. That is introducing or filling the sound absorber with the means 17 can take place before or after installation of the sound absorber into a vehicle or a machine. It is also optionally possible to close the sound absorber after introduction of the means 17 and after the activation or heating.

What is claimed is:

1. A method of manufacturing means for acoustic and thermal insulation, particularly at high temperatures, comprising:
providing an insulating and damping material;
shaping of the insulating and damping material having geometric shapes, such as spherical or elliptical shapes, by shaping processes, for example forming into a ball and/or foaming up.

2. The method according to claim 1, wherein a binder is added before or during or after shaping.

3. The method according to claim 1, wherein the insulating and damping material is fiber-like formed and comprises a textile fiber, a silica glass fiber, a ceramic fiber; or a mixture of several of these fibers; wherein the insulating and damping material is at least partially formed of continuous fiber; wherein the continuous fiber is ECR fiber or a standard E-glass fiber.

4. The method according to claim 1, wherein the insulating and damping material may include foams, in particular solid foams.

5. The method according to claim 1, further comprising the step of:
setting a temperature above which the insulating and damping material changes its volume only at a first activating, and in particular, increases its volume.

6. The method according to claim 1, wherein a diameter of the ball type means shaped in geometrical shapes, in particular spherical or elliptical shapes, can vary starting from 3 mm.

7. The method according to claim 1, wherein the ball shaped means are spherical and comprise two types of ball shaped means, having two different radii, respectively, wherein the ratio of the two radii is constant and in particular the ratio of the radii is about 2.415.

8. Means for acoustic and thermal insulation, particularly at high temperatures, made by a method according to claim 1.

9. A method of manufacturing high temperature-sound absorbers, comprising the steps of:
providing a first casing shell;
providing a second casing shell or a direct hot gas-carrying member;
providing means for acoustic and thermal insulation in accordance with claim 8;
connecting the first casing shell with the second casing shell or of the right of hot gas carrying component such that a gap is formed between them, which is at least partially enclosed by the shell elements;
introducing the means for acoustic and thermal insulation into the gap between the first and the second casing shell; and
activating the means for acoustic and thermal insulation in the gap.

10. The method of claim 9, wherein the introduction of the means for acoustic and thermal insulation comprises pouring the means into the gap and/or a blowing the means into the gap; wherein the activation of the means for the acoustic and thermal insulation can be carried out before or after installation of the high-temperature sound absorber in a vehicle.

11. The method according to claim 10, wherein the activation of the means for acoustic and thermal insulation after installing the high-temperature sound absorber in a vehicle is performed during a first test drive, or a first test run of an engine in the vehicle.

12. The method according to claim 9, wherein the first and/or second casing shell have a perforation.

13. The high-temperature sound absorber manufactured by the method according to claim 9.

14. Means for acoustic and thermal insulation, especially at high temperatures comprising an insulating and damping material, said insulating and damping material being a ball having geometric shapes, such as spherical or elliptical shapes, by a shaping processes, such as forming into a ball and/or foaming up.

15. The means of claim 14, wherein the insulating and damping material is fiber-shaped and is at least partially formed of continuous fiber; wherein the continuous fiber is ECR fiber or a standard E-glass fiber; or wherein the insulating and damping material comprises foams, in particular solid foams.

16. A sound absorber having acoustic and thermal insulation properties comprising:
a first surface;
a second surface;
a gap formed between said first and second surfaces;
a plurality of balls placed within said gap, said plurality of balls comprising balls having at least two different diameters; and
wherein said plurality of balls increase in volume only when initially activated and do not thereafter change in volume,
whereby said plurality of balls and the at least two different diameters efficiently fill said gap.

17. A sound absorber having acoustic and thermal insulation properties as in claim 16, wherein:
the initial activation comprises heated said plurality of balls to a predetermined temperature.

18. A sound absorber having acoustic and thermal insulation properties as in claim 16, wherein:
said plurality of balls are spherical and a ratio of one of said at least two different diameters and another one of said at least two different diameters is about 2.415.
